(19) United States
(12) Patent Application Publication
(10) Pub. No.: US 2020/0091716 A1
(43) Pub. Date: Mar. 19, 2020

(54) METHOD AND SYSTEM FOR ACQUIRING SEVEREST VOLTAGE STABILITY MARGIN BASED ON COORDINATED CONTINUATION POWER FLOW

(71) Applicant: Tsinghua University, Beijing (CN)

(72) Inventors: Ying CHEN, Beijing (CN); Zhengwei REN, Beijing (CN); Shaowei HUANG, Beijing (CN); Chen SHEN, Beijing (CN)

(21) Appl. No.: 16/505,319

(22) Filed: Jul. 8, 2019

(30) Foreign Application Priority Data
Jul. 2, 2018 (CN) 2018107076917

(51) Int. Cl. H02J 3/06

(52) U.S. Cl. CPC H02J 3/06; H02J 2003/007

(57) ABSTRACT

An acquisition method of the severest voltage stability margin based on coordinated continuation power flow is disclosed comprising: S1, calculating a partial derivative of initial voltage amplitude of a critical node with respect to the load level of each partition under the current load; S2, calculating the amount of the load growth of each partition according to the partial derivative and a preset load growth step length, and updating the active power output and current load based on a coordinated continuation power flow model; S3, judging whether a new voltage amplitude of the updated critical node is less than the initial voltage amplitude if the updated coordinated power flow converges; S4, judging whether the preset load growth step length is less than a convergence threshold if the new voltage amplitude is greater than or equal to the initial voltage amplitude, and acquiring the severest voltage stability margin if so.

### CROSS-REFERENCE TO RELATED APPLICATIONS

The present application claims priority under 35 U.S.C. § 119(a) to Chinese Patent Application No. 2018107076917, filed on Jul. 2, 2018, the disclosure of which is incorporated herein by reference in its entirety.

### FIELD OF TECHNOLOGY

The present disclosure relates to the field of power system technologies, and more specifically, to a method and system for acquiring the severest voltage stability margin based on coordinated continuation power flow.

### BACKGROUND

In the process of acquiring a static voltage stability margin through a traditional continuation power flow method, loads in respective regions and active power outputs of generators increase in the same proportion. In actual situations, especially for interconnected power systems, regional power grids often have large differences in time and space. Therefore, loads have different variation characteristics and growing the loads by a uniform proportion is inconsistent with the actual situation. Among the different modes of the load variation in the respective regions, the worst growth mode should exist, which corresponds to the severest value of the voltage stability margin of the interconnected power system, that is, the severest voltage stability margin.

In addition, the traditional continuous power flow method is a centralized calculation method while in the actual power system, it is difficult to splice data from respective regional power grids together or spliced data have such problems as simplification and time asynchronization etc., since information barriers exist among dispatching centers in the respective regional power grids. Using distributed calculation methods, local calculating resources and data can be fully utilized, thereby realizing non-simplified and accurate analysis.

In previous work, the influence of different load growth direction on Voltage Stability Margin (VSM) was considered when the VSM was calculated. In the prior art, the sensitivity of the compound growth of nodes to the VSM is analyzed, thereby establishing corresponding control measures to avoid voltage collapse. The influence of the load growth modes and the generator scheduling on the VSM was analyzed when the VSM was calculated. A “hyper-cone” model was proposed to study the severest voltage stability margin (Severest VSM, SVSM) and although the uncertainty of the load growth was considered, the reactive power output constraint of the generator is ignored. The predicted load is also used to calculate the VSM, which is more consistent with the actual operation.

However, all of the above existing technologies use centralized methods for analyzing the VSM of the power grid and are not suitable for analyzing the VSM of the interconnected power network. Therefore, it is necessary to establish a model for the SVSM of the regional power grids and propose a corresponding search algorithm.

Firstly, interconnected power networks are composed of different regional power grids, each regional power grid has a regional dispatching center that is responsible for analysis and calculation within the regional power grid under the jurisdiction; an upper-class dispatching center, which is responsible for the analysis and management of the entire interconnected power grid, exists above all of the regional dispatching centers.

Secondly, the dispatching center has all the data of the regional power grid under the jurisdiction while an external power grid is processed by performing equivalence at the boundary.

Thirdly, each regional dispatching center can only solve the VSM of the regional power grid under the jurisdiction, making an analysis using the traditional centralized continuation power flow method and proportionally grow all loads and the active power outputs of the generators.

The power-grid model and data in the upper-class dispatching center are spliced from the regional dispatching centers. There are model simplification and data asynchronization problems in the splicing process.

According to the characteristics above, for the regional dispatching centers, the regional VSM acquired from the solution is not accurate since the influence of the external power grid cannot be considered in the analysis; for the upper-class dispatching center, the loads of various regions grow according to the same growth proportion, which is inconsistent with the actual situation and thus the severest voltage stability margin acquired is also inaccurate.

### SUMMARY

The present disclosure provides a method and system for acquiring the severest voltage stability margin based on coordinated continuation power flow that overcomes the problems above.

According to an aspect of the present disclosure, a method for acquiring the severest voltage stability margin based on coordinated continuation power flow is provided, which may include: S1, acquiring a critical node of an interconnected power system under a current load and calculating a partial derivative of initial voltage amplitude of the critical node with respect to the load level of each partition of the interconnected power system; S2, calculating the amount of the load growth of each partition of the interconnected power system according to the partial derivative and a preset load growth step length, and updating the active power output and the current load in the interconnected power system according to the amount of the load growth based on a coordinated continuation power flow model; S3, judging whether a new voltage amplitude of the updated critical node is less than the initial voltage amplitude if the coordinated power flow of the updated interconnected power system converges; S4, judging whether the preset load growth step length is less than a corresponding convergence threshold if the new voltage amplitude is greater than or equal to the initial voltage amplitude, and acquiring the severest voltage stability margin based on the loads of the updated interconnected power system if the preset load growth step length is less than the corresponding convergence threshold.

According to another aspect of the present disclosure, a system for acquiring the severest voltage stability margin based on coordinated continuation power flow is provided, which may include: a partial derivative acquisition module, for acquiring a critical node of an interconnected power system under a current load and calculating a partial derivative of initial voltage amplitude of the critical node with respect to the load level of each partition of the interconnected power system; an updating module, for calculating the amount of the load growth of each partition of the interconnected power system according to the partial derivative and a preset load growth step length, and updating the active power output and the current load in the interconnected power system according to the amount of the load growth based on a coordinated continuation power flow model; a voltage judgment module, for judging whether a new voltage amplitude of the updated critical node is less than the initial voltage amplitude if the coordinated power flow of the updated interconnected power system converges; the severest voltage stability margin acquisition module, for judging whether the preset load growth step length is less than a corresponding convergence threshold if the new voltage amplitude is greater than or equal to the initial voltage amplitude, and acquiring the severest voltage stability margin based on the updated loads of the interconnected power system if the preset load growth step length is less than the corresponding convergence threshold.

According to the method and system for acquiring the severest voltage stability margin based on coordinated continuation power flow provided by the present application, by arranging a critical node for establishing an accurate interconnected power system, and then establishing a more accurate coordinated continuation power flow model, the influence of regional load growth modes on the voltage stability of the entire interconnected system may be more accurately analyzed and the severest voltage stability margin caused by the worst load growth direction may be searched, thereby providing a reference for actual dispatching, generation and operation.

### BRIEF DESCRIPTION OF THE DRAWINGS

FIG. 1 is a flowchart of a method for acquiring the severest voltage stability margin based on coordinated continuation power flow according to an embodiment of the present disclosure;

FIG. 2 is a flowchart of another method for acquiring the severest voltage stability margin based on coordinated continuation power flow according to an embodiment of the present disclosure;

FIG. 3 is a dividing schematic diagram of a partitioned interconnected power system according to an embodiment of the present disclosure; and

FIG. 4 is a block diagram of a system for acquiring the severest voltage stability margin based on coordinated continuation power flow according to an embodiment of the present disclosure.

### DESCRIPTION OF THE EMBODIMENTS

The specific embodiments of the present disclosure are further described in detail below in conjunction with the drawings and embodiments. The following examples are intended to illustrate the present disclosure but are not intended to limit the scope of the present disclosure.

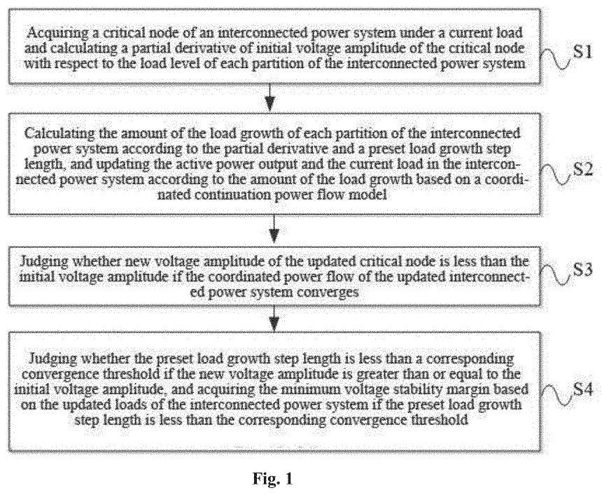

FIG. 1 is a flowchart of a method for acquiring the severest voltage stability margin based on coordinated continuation power flow according to an embodiment of the present disclosure. As shown in FIG. 1, the method may include: S1, acquiring a critical node of an interconnected power system under a current load and calculating a partial derivative of initial voltage amplitude of the critical node with respect to the load level of each partition of the interconnected power system; S2, calculating the amount of the load growth of each partition of the interconnected power system according to the partial derivative and a preset load growth step length, and updating the active power output and the current load in the interconnected power system according to the amount of the load growth based on a coordinated continuation power flow model; S3, judging whether a new voltage amplitude of the updated critical node is less than the initial voltage amplitude if the coordinated power flow of the updated interconnected power system converges; S4, judging whether the preset load growth step length is less than a corresponding convergence threshold if the new voltage amplitude is greater than or equal to the initial voltage amplitude, and acquiring the severest voltage stability margin based on the updated loads of the interconnected power system if the preset load growth step length is less than the corresponding convergence threshold.

Firstly, step S1 in the embodiment of the present disclosure is to acquire a critical node and a partial derivative. The critical node reflects a node of which the voltage is the most unstable and weakest in the entire interconnected power system. In the entire interconnected power system, the critical node is a node position at which the voltage dips fastest and is the most unstable when the load grows. In the embodiment of the present disclosure, the critical node is selected to select the severest voltage stability margin, the active power output and the current load in the interconnected power system may be updated for the node at which the voltage dips fastest and is the most unstable, which may play promoting function in the accurate selection of the severest voltage stability margin caused by the worst load growth direction compared with the update of non-critical nodes. The partial derivative of the voltage amplitude of the critical node to the current load represents the worst growth direction of the regional load.

Secondly, in step S2, the active power output and the current load in the interconnected power system are updated based on the coordinated continuation power flow model. It should be noted that continuation power flow (CPF), is a powerful tool for voltage stability analysis in a power system. In an embodiment of the present disclosure, voltage stability margin (VSM) refers to a maximum load level at which the voltage of a power system collapses as the load of the power system increases. In the embodiment of the present disclosure, the influence of the regional load growth modes on the voltage stability of the entire interconnected power system can be more accurately analyzed by adopting a coordinated continuation power flow based on the voltage stability analysis characteristics.

Thirdly, in step S3, whether the new voltage amplitude of the updated critical node is less than the initial voltage amplitude is judged if the coordinated power flow of the updated interconnected power system converges. For the coordinated power flow, convergence or divergence is distinguished. The severest voltage stability margin caused by the worst load growth direction can be searched only when the coordinated power flow converges and the voltage of the critical node is large, that is, greater than a set voltage.

Finally, in step S4, when the new voltage amplitude is greater than or equal to the initial voltage amplitude, and the preset load growth step length is less than the corresponding convergence threshold, the severest voltage stability margin is acquired based on the updated loads of the interconnected power system. In an embodiment of the present disclosure, the load growth step length is a factor for adjusting the load growth, that is, the setting of the load growth step length indirectly affects the updated loads of the interconnected power system, and thus it is necessary to judge the relationship between the preset load growth step length and the convergence threshold of the updated interconnected power system. The severest voltage stability margin can be calculated only when the preset load growth step length is less than the convergence threshold of the updated interconnected power system. The finally acquired severest voltage stability margin is based on the updated load level of the interconnected power system and is an index of the updated interconnected power system.

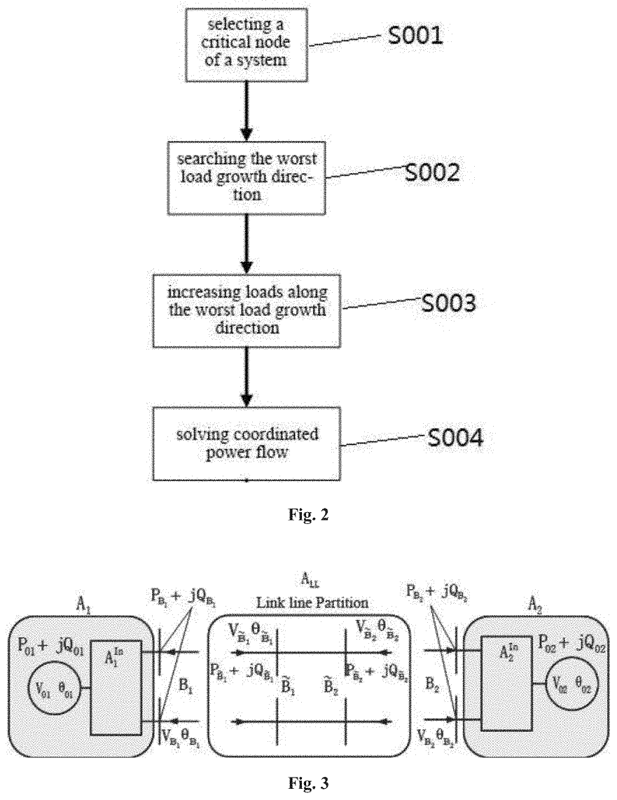

FIG. 2 is a flowchart of another method for acquiring the severest voltage stability margin based on coordinated continuation power flow according to an embodiment of the present disclosure. Please refer to FIG. 2 for this embodiment. In FIG. 2:

S001, a critical node of the system is selected. The critical node of the system is the node at which the static voltage stability in the system is the weakest.

The critical node reflects a node at which the voltage of the entire interconnected power system is the most unstable and weakest. In the entire interconnected power system, the critical node is a node position at which the voltage dips fastest and is the most unstable when the load grows. In the embodiment of the present disclosure, the critical node is selected to select the severest voltage stability margin, the active power output and the current load in the interconnected power system may be updated for the node at which the voltage dips fastest and is the most unstable, which may play promoting function in the accurate selection of the severest voltage stability margin caused by the worst load growth direction compared with the update of non-critical nodes.

S002, the regional worst load growth direction (WLD) of the system is searched based on the critical node. It is believed that the voltage of the system, especially of the critical node dip fastest and the system is most prone to the problem of voltage stability when the load grows along this direction.

The partial derivative of the voltage amplitude of the critical node with respect to the current load represents the regional worst load growth direction.

S003, the loads within respective regions are adjusted along the regional worst load growth direction (WLD).

S004, a coordinated power flow calculation is made once at the new load level.

The whole process from step S001 to step S004 constitutes a coordinated continuation power flow (Coordinated CPF, CCPF).

Step S001 corresponds to acquiring the critical node of the interconnected power system under the current load in the step S1 of FIG. 1. Step S002 corresponds to calculating a partial derivative of initial voltage amplitude with respect to the load level of each partition of the interconnected power system in the step S1 of FIG. 1.

Step S003 corresponds to the step S2 in FIG. 1. Step S004 corresponds to steps S3 and S4 in FIG. 1. Therefore, the method for acquiring the severest voltage stability margin based on coordinated continuation power flow shown in FIG. 2 are equivalent to that shown in FIG. 1.

According to the method for acquiring the severest voltage stability margin based on coordinated continuation power flow provided by the present application, by arranging a critical node for establishing an accurate interconnected power system, and then establishing a more accurate coordinated continuation power flow model, the influence of regional load growth modes on the voltage stability of the entire interconnected system may be more accurately analyzed and the severest voltage stability margin caused by the worst load growth direction may be searched, thereby providing a reference for the actual dispatching, generation and operation.

Based on the embodiments above, the step S4 further includes: assigning a value of the new voltage amplitude to the initial voltage amplitude and performing steps S1 to S3 cyclically until the new voltage amplitude is greater than or equal to the initial voltage amplitude, if the new voltage amplitude is less than the initial voltage amplitude.

It should be noted that the present embodiment represents one cyclic process in which the value of the voltage of the critical node of the current time is assigned to the initial voltage amplitude during each cycle.

It should also be noted that the voltage of the critical node in the embodiment of the present disclosure is not a fixed value, but a real-time calculated value in the process step.

Based on the embodiments above, step S4 further includes: decreasing a value of the preset load growth step length, recovering the updated loads of the interconnected power system to that before the updating and performing steps S1 to S3 cyclically until the preset load growth step length is less than the corresponding convergence threshold, if the preset load growth step length is greater than or equal to the corresponding convergence threshold.

Specifically, recovering updated the loads of the interconnected power system to that before the updating refers to recovering the updated loads of the interconnected power system to the current load in the embodiment of the present disclosure.

It should be noted that the current load in the embodiment of the present disclosure is not the “current” load measured in real time, but is a fixed value.

According to the method for acquiring the severest voltage stability margin based on coordinated continuation power flow provided by the present application, by setting the preset load growth step length being less than the corresponding convergence threshold, acquisition of the SVSM may be more accurate and synchronized.

Based on the embodiments above, the acquisition of the critical node in the interconnected power system under the current load in the step S1 further includes: acquiring the critical-node synergic indices (CNSIs) of all the nodes in an arbitrary region of the interconnected power system based on a CNSI equation, and selecting a regional critical node of the arbitrary region based on the CNSIs of all the nodes; selecting the critical node of the interconnected power system under the current load from the regional critical nodes of all the regions; the CNSI equation is as follows:

S_{k,i}=E_{k,i}(δₘᵢₙ^{k},Vᵢ)−R_{k,i}(Qₖ^{B},Vᵢ)

In the equation, S_{k,i} is the CNSI, E_{k, i}(δₘᵢₙ^{k}, Vᵢ) is a derivative of the minimum singular value of the Jacobian matrix of the power flow equation of the region in which the node is located, with respect to the voltage amplitude of the node, Sₘᵢₙ^{k}, is the minimum singular value of the Jacobian matrix of the power flow equation of the region in which the node is located, k represents the k-th regional power grid, i represents the i-th node, Vᵢ is the voltage amplitude of the node, R_{k, i}(Qₖ^{B}, Vᵢ) is the partial derivative of an external reactive power injection amount with respect to the voltage amplitude of the node, Qₖ^{B} is the external reactive power injection amount, and B represents the boundary.

It should be noted that any region and any partition in the embodiment of the present disclosure have the same concept.

Specifically,

$${E}_{k , i} ( {δ}_{m i n}^{k} , {V}_{i} ) = \frac{\partial {δ}_{m i n}^{k}}{\partial {V}_{i}}$$

partly reflects the influence of the node voltage on the stability of the regional power grid. The voltage amplitude of the critical node should have the greatest influence on the minimum singular value, that is, E_{k, i}(δₘᵢₙ^{k}, Vᵢ) should be the largest.

Specifically, this partly reflects the amount of reactive power injected from the outside through the boundary node when the regional power grid is approaching the voltage collapse point. For the critical node, it is necessary to absorb a large amount of reactive power from the outside when its voltage assignment is on the verge of collapse and thus R_{k, i}(Qₖ^{B}, Vᵢ) of the critical node should have a maximum value. Since R_{k, i}(Qₖ^{B}, Vᵢ) is a negative number, this value is reversed when it constitutes a synergic index.

Based on the embodiments above, selecting a regional critical node of the arbitrary region based on the CNSIs of all the nodes further includes: selecting a node of which both E_{k, i}(δₘᵢₙ^{k}, Vᵢ) and R_{k, i}(Qₖ^{B}, Vᵢ) have the maximum value among the CNSIs of all the nodes as the regional critical node of the arbitrary region.

The critical node of the system reflects the weakest part of voltage stability in the entire system. For the interconnected power systems, the critical node of the system should be a node in which the voltage stability is the weakest among various partitions. In the present disclosure, a synergic index is proposed to evaluate the voltage stability of the respective regional nodes, the critical node of the present region can be selected by each regional dispatching center according to the index in each region and then the critical node of the entire grid can be selected by the upper-class dispatching center from the critical nodes of various regions.

The synergic index for the selection of the critical node of the system is a coordinated selection index which is selected inside each partition but in which the influence of the external partitions on the present partition is considered at the same time, and thus the selected result is identical to the result selected in the entire grid in a centralized manner.

According to the method for acquiring the severest voltage stability margin based on the coordinated continuation power flow provided by the disclosure, more accurate critical nodes can be acquired by setting the CNSI. Since the power grids in the respective regions are used in the calculation simultaneously, the method is more accurate than external grid equivalence method for the calculation of the power flow by considering the mutual influence between the regional power grids.

Based on the embodiments above, in step S2, the amount of the load growth of each partition of the interconnected power system is calculated according to the partial derivative and a preset load growth step length by the following equation:

$$Δ λ = s \cdot \frac{\frac{\partial {V}_{cb}}{\partial λ}}{{‖ \frac{\partial {V}_{cb}}{\partial λ} ‖}_{2}} ;$$

In the equation above, Δλ is the amount of the load growth of each partition of the interconnected power system, s is the preset load growth step length,

$$\frac{\partial {V}_{cb}}{\partial λ} = [ \frac{\partial {V}_{cb}}{\partial {λ}_{1}} , \frac{\partial {V}_{cb}}{\partial {λ}_{2}} , … , \frac{\partial {V}_{cb}}{\partial {λ}_{M}} ]$$

is the partial derivative of the initial voltage amplitude of the critical node with respect to the load level of the respective partitions of the interconnected power system, M is the number of regional power grids, V_{cb} is the voltage of the critical node, and λ_{M} is the load of the M-th regional power grid, and wherein

$$\frac{\partial {V}_{cb}}{\partial λ}$$

is calculated by the finite difference method.

Specifically, the preset load growth step length is used to adjust the norm of the partial derivative.

Calculating

$$\frac{\partial {V}_{cb}}{\partial λ}$$

by the finite difference method specifically includes:

(1) calculating V_{cb}=f_{cb}(λ₁, . . . λ₁, . . . λ_{M}), λ=λ₁, . . . , λ_{M} as the current load level using the coordinated power flow;

(2) i=1, 2, . . . , M, sequentially calculating V_{cb}′=f_{cb}(λ₁, . . . , λᵢ+ζ, . . . , λ_{M}), ζ is a small increment, called as a finite difference step length.

(3) Calculating

$$\frac{\partial {V}_{cb}}{\partial λ} = \frac{{f}_{cb} ( {λ}_{1} , … , {λ}_{i} + ζ , … , {λ}_{M} ) - {f}_{cb} ( {λ}_{1} , … , {λ}_{i} , … , {λ}_{M} )}{ζ} ,$$

let i=i+1, if i≤M, proceeding to Step S2, otherwise the calculation is terminated and

$$\frac{\partial {V}_{cb}}{\partial λ}$$

is acquired.

It should be noted that the relationship between V_{cb} and λ is denoted as V_{cb}=f_{cb}(λ). For each assigned λ, V_{cb} can be calculated by performing a coordinated power flow.

Based on the embodiments above, in step S2, updating the active power output and the current load in the interconnected power system according to the amount of the load growth based on the coordinated continuation power flow model further includes:

updating the active power output and the current load in the interconnected power system according to the amount of the load growth based on the coordinated continuation power flow model by using the following equation:

$$\{ \begin{matrix}{p}_{Gk} = {p}_{Gk}^{0} + {λ}_{k} \cdot {p}_{Gk}^{0} \\ {p}_{Lk} = {p}_{Lk}^{0} + {λ}_{k} \cdot {p}_{Lk}^{0} \\ {q}_{Lk} = {q}_{Lk}^{0} + {λ}_{k} \cdot {q}_{Lk}^{0}\end{matrix} ;$$

In the equation above, p_{Gk} is the active power output of the generator of the kth regional power grid, p_{Lk} is the active load of the kth regional power grid, q_{Lk} is the reactive load of the kth regional power grid, p_{Gk}⁰ is the active power output of the generator corresponding to the base state, p_{Lk}⁰ is active load corresponding to the base state, q_{Lk}⁰ is the reactive load corresponding to the base state and λₖ is the load level of the k-th regional power grid.

The coordinated continuation power flow model is:

G(Y,λ)=0;

In the equation above, Y is a set of algebraic variables of coordinated continuation power flow calculation and λ is the load level.

It should be noted that λ is used to adjust the load in the power grid and the power output of the generator. In the embodiment of the present disclosure, the power grid also refers to an interconnected power system.

Based on the embodiments above, step S3 further includes: S31, dividing the interconnected power system into a calculating side and a coordinating side; S32, receiving a power injection vector of a boundary node and a phase angle of a balanced node observed from the regional power grid transmitted from the coordinating side, and transmitting the power injection vector of the boundary node and the phase angle of the balanced node observed from the regional power grid transmitted to the calculating side such that the calculating side acquires a boundary voltage vector and an unbalanced power vector of each region by the following equation:

[U_{B},Pₗₒₛₛ,]=f_{Ω}(P_{B}^{t},Q_{B}^{t},θ₀^{t});

In the equation above, U_{B} is the boundary voltage vector, Pₗₒₛₛ is the unbalanced power vector of each region, [P_{B}^{t}, Q_{B}^{t}] is the power injection vector of the boundary node observed from the regional power grid, θ₀^{t} is the phase angle of the balanced node, and f_{Ω} corresponds to the regional power flow;

S33, receiving the boundary voltage vector and the unbalanced power vector of each region transmitted from the calculating side, and transmitting the boundary voltage vector and unbalanced power vector of each region to the coordinating side, such that the coordinating side acquires an injection power of link lines through the following equation;

[P_{\tilde{B}},Q_{\tilde{B}}]=f_{All}(U_{\tilde{B}});

In the equation above, [P_{\tilde{B}}, Q_{\tilde{B}}] is a power injection vector of the boundary node observed from the coordinating side, U_{\tilde{B}}=U_{B}, U_{\tilde{B}} is the boundary voltage vector transmitted to the coordinating side, and f_{All} corresponds to the link line partition power flow equation;

S34, judging whether the following coordination equation is true:

$$\{ \begin{matrix}{P}_{B}^{t} - {P}_{\tilde{B}}^{t} = 0 \\ {Q}_{B}^{t} - {Q}_{\tilde{B}}^{t} = 0 \\ {P}_{loss} - K \cdot {P}_{loss}^{all} = 0\end{matrix}$$

In the equation above, [P_{B}^{t}, Q_{B}^{t}] is the power injection vector of the boundary node observed from the regional power grid, [P_{\tilde{B}}, Q_{\tilde{B}}] is the power injection vector of the boundary node observed from the coordinating side, Pₗₒₛₛ is the unbalanced power vector of each region, K is an unbalanced power distribution coefficient, and Pₗₒₛₛ^{all} is the unbalanced power vector of all regions;

If so, the coordinated power flow of the updated interconnected power system converges and whether the voltage of the critical node is less than the set voltage is further determined.

FIG. 3 is a dividing schematic diagram of a partitioned interconnected power system according to an embodiment of the present disclosure. Please refer to FIG. 3 for this embodiment.

In FIG. 3, each regional power grid has one balanced node of which voltage and phase angle value correspond to V₀₁, θ₀₁, and V₀₂, θ₀₂, respectively. P₁₀, Q₁₀, P₂₀, and Q₂₀ correspond to active and reactive powers of the balanced node, respectively.

It should be noted that for the two-partition interconnected power grid, it can be divided into three sub-regions, that is, two regional power grids (corresponding to the calculating side in coordinated calculation) and one link line partition (corresponding to the coordinating side in coordinated calculation).

Based on the embodiments above, after step S34, the method further includes: S35, If not, the coordinated power flow of the updated interconnected power system does not reach convergence, then acquiring the residual errors by the following equation:

$$\{ \begin{matrix}{P}_{B}^{t} - {P}_{\tilde{B}}^{t} = {dP}_{B} \\ {Q}_{B}^{t} - {Q}_{\tilde{B}}^{t} = {dQ}_{B} \\ {P}_{loss} - K \cdot {P}_{loss}^{all} = {dP}_{loss}\end{matrix} ;$$

In the equation above, [P_{B}^{t}, Q_{B}^{t}] is the power injection vector of the boundary node observed from the regional power grid, [P_{\tilde{B}}, Q_{\tilde{B}}] is the power injection vector of the boundary node observed from the coordinating side, Pₗₒₛₛ is the unbalanced power vector of each region, K is the unbalanced power distribution coefficient. Pₗₒₛₛ^{all} is the unbalanced power vector of all regions, and dP_{B}, dQ_{B} and dPₗₒₛₛ^{all} are residual errors;

S36, calculating corrected values by using a JFNG(m) algorithm based on the residual errors, and correcting the power injection vector of the boundary node observed from the regional power grid and the phase angle of the balanced node by using the following equation based on the corrected values:

$$\{ \begin{matrix}{P}_{B}^{t + 1} = {P}_{B}^{t} + Δ {P}_{B} \\ {Q}_{B}^{t + 1} = {Q}_{B}^{t} + Δ {Q}_{B} \\ {θ}_{0}^{t + 1} = {θ}_{0}^{t} + Δ {θ}_{0}\end{matrix}$$

In the equation above, [P_{B}^{t}, Q_{B}^{t}] is the power injection vector of the boundary node observed from the regional power grid, θ₀^{t} is a phase angle of the balanced node, [P_{B}^{t+1}, Q_{B}^{t+1}] is a corrected power injection vector of the boundary node observed from the regional power grid, θ₀^{t+1} is a corrected phase angle of the balanced node, and ΔP_{B}, ΔQ_{B} and Δθ₀ are all corrected values;

S37, cyclically performing steps S1 to S3 until the coordinated power flow of the updated interconnected power system converges.

Further, the judgment of the convergence according to the embodiment of the present disclosure can be illustrated by the following description:

Data exchange: P_{b}^{t}, Q_{B}^{t}, θ₀^{t} are transmitted to the calculating side by the coordinating side;

Calculating side: power flow calculation of the regional power grid is performed, thereby obtaining:

[U_{B},Pₗₒₛₛ,]=f_{Ω}(P_{B}^{t},Q_{B}^{t},θ₀^{t});

Data exchange: U_{B}, Pₗₒₛₛ are transmitted by the calculating side to the coordinating side;

Coordinating side: let U_{\tilde{B}}=U_{B}, and the injection power of the link lines is calculated:

[P_{\tilde{B}},Q_{\tilde{B}}]=f_{All}(U_{\tilde{B}});

and whether the following equation is true is checked:

$$\{ \begin{matrix}{P}_{B}^{t} - {P}_{\tilde{B}}^{t} = 0 \\ {Q}_{B}^{t} - {Q}_{\tilde{B}}^{t} = 0 \\ {P}_{loss} - K \cdot {P}_{loss}^{all} = 0\end{matrix} ;$$

If the equation is true, the coordinated power flow calculation converges; otherwise, the residual errors are calculated by the following equation, and the process proceeds to the step 5):

$$\{ \begin{matrix}{P}_{B}^{t} - {P}_{\tilde{B}}^{t} = {dP}_{B} \\ {Q}_{B}^{t} - {Q}_{\tilde{B}}^{t} = {dQ}_{B} \\ {P}_{loss} - K \cdot {P}_{loss}^{all} = {dP}_{loss}\end{matrix} ;$$

Coordinating side: P_{B}, ΔQ_{B} and Δθ₀ are calculated by using the JFNG(m) algorithm based on the residual errors dP_{B}, dQ_{B}, and dPₗₒₛₛ in the equation above. P_{B}^{t}, Q_{B}^{t} and θ₀^{t} are corrected by using the following equation and the process proceeds to Step 1.

$$\{ \begin{matrix}{P}_{B}^{t + 1} = {P}_{B}^{t} + Δ {P}_{B} \\ {Q}_{B}^{t + 1} = {Q}_{B}^{t} + Δ {Q}_{B} \\ {θ}_{0}^{t + 1} = {θ}_{0}^{t} + Δ {θ}_{0}\end{matrix} ;$$

In the equations above, U_{B} is the boundary voltage vector transmitted to the regional power grid, U_{\tilde{B}} is the boundary voltage vector transmitted to the coordinating side, [P_{B}^{t}, Q_{B}^{t}] and [P_{\tilde{B}}^{t}, Q_{\tilde{B}}^{t}] are the power injection vectors of the boundary node observed from the regional power grid and coordinating side, respectively, θ₀^{t} is a phase angle of the balanced node, Pₗₒₛₛ is the unbalanced power vector of each region, Pₗₒₛₛ^{all} is the total unbalanced power of all regions, K is the unbalanced power distribution coefficient, which will be generated automatically during the calculating, and f_{Ω} and f_{All} correspond to the regional power flow and power flow of the link line partition, respectively.

It should be noted that JFNG, called Jacobian-Free Newton GMRES by full name, is an inexact Newton method based on generalized minimal residual with preprocessing mechanism, which can be used to solve nonlinear equations without explicit generation of Jacobi matrix.

The present disclosure provides a method for searching the severest voltage stability margin in which the full use of calculating resources and accurate data of each regional power grid itself is made through coordinated calculation based on coordinated continuation power flow, and the purpose is to utilize more accurate and synchronous models and data. By the method, the worst load growth direction (WLD) is found and the severest voltage stability margin (SVSM) of an interconnected power system is acquired. The present disclosure is intended to find the worst load growth mode among various regions in the interconnected power system and the severest voltage stability margin corresponding thereto, thereby providing a reference for maintaining the stability of the power system in actual dispatching operation.

The coordinated continuation power flow calculation is performed by each regional dispatching center, and each regional dispatching center directly participates in the calculation, and thus the model used is more complete and the data is more accurate.

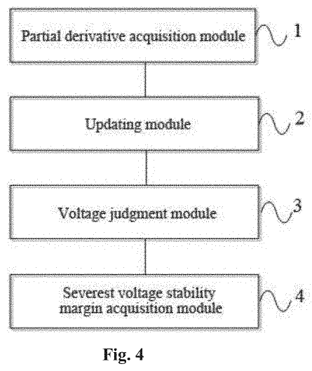

According to an embodiment of the present disclosure, a system for acquiring the severest voltage stability margin based on coordinated continuation power flow is further provided. FIG. 4 is a module diagram illustrating a system for acquiring the severest voltage stability margin based on coordinated continuation power flow according to an embodiment of the present disclosure. As shown in FIG. 4, the acquiring system may include: a partial derivative acquisition module 1, for acquiring a critical node of an interconnected power system under a current load, and calculating a partial derivative of initial voltage amplitude of the critical node with respect to the load level of each partition of the interconnected power system; an updating module 2, for calculating the amount of the load growth of each partition of the interconnected power system according to the partial derivative and a preset load growth step length, and updating the active power output and the current load in the interconnected power system according to the amount of the load growth based on a coordinated continuation power flow model; a voltage judgment module 3, for judging whether a new voltage amplitude of the updated critical node is less than the initial voltage amplitude if the coordinated power flow of the updated interconnected power system converges; and the severest voltage stability margin acquisition module 4, for judging whether the preset load growth step length is less than a corresponding convergence threshold if the new voltage amplitude is greater than or equal to the initial voltage amplitude, and acquiring the severest voltage stability margin based on the updated loads of the interconnected power system if the preset load growth step length is less than the corresponding convergence threshold.

It should be noted that the above-mentioned partial derivative acquisition module 1, updating module 2, voltage judgment module 3 and severest voltage stability margin acquisition module 4 cooperate to perform one of the methods for acquiring the severest voltage stability margin based on the coordinated continuation power flow according to the embodiments above. The specific function of the system refers to the foregoing embodiments of the acquisition methods and details are not described herein again.

According to the method and system for acquiring the severest voltage stability margin based on coordinated continuation power flow provided by the present application, by arranging a critical node for establishing an accurate interconnected power system, and then establishing a more accurate coordinated continuation power flow model, the influence of regional load growth modes on the voltage stability of the entire interconnected system may be more accurately analyzed and the severest voltage stability margin caused by the worst load growth direction may be searched, thereby providing a reference for the actual schedules of production and operation.

Finally, the methods of the present disclosure are only preferred embodiments and not intended to limit the scope of the present disclosure. Any modification, equivalent substitution, improvement, etc. made within the spirit and scopes of the present disclosure are intended to be included within the scope of the present disclosure.

What is claimed is:

1. An acquisition method for the severest voltage stability margin based on coordinated continuation power flow, comprising:
S1, acquiring a critical node of an interconnected power system under a current load, and calculating a partial derivative of initial voltage amplitude of the critical node with respect to the load level of each partition of the interconnected power system;
S2, calculating an amount of the load growth of each partition of the interconnected power system according to the partial derivative and a preset load growth step length, and updating an active power output and the current load in the interconnected power system according to the amount of the load growth based on a coordinated continuation power flow model;
S3, judging whether a new voltage amplitude of the updated critical node is less than the initial voltage amplitude if the coordinated power flow of the updated interconnected power system converges;
S4, judging whether the preset load growth step length is less than a corresponding convergence threshold if the new voltage amplitude is greater than or equal to the initial voltage amplitude, and acquiring the severest voltage stability margin based on the updated loads of the interconnected power system if the preset load growth step length is less than the corresponding convergence threshold.

2. The acquisition method of claim 1, wherein step S4 further comprises:
assigning a value of the new voltage amplitude to the initial voltage amplitude and performing steps S1 to S3 cyclically until the new voltage amplitude is greater than or equal to the initial voltage amplitude, if the new voltage amplitude is less than the initial voltage amplitude.

3. The acquisition method of claim 1, wherein step S4 further comprises:
decreasing a value of the preset load growth step length, recovering the updated loads of the interconnected power system to that before the updating and performing steps S1 to S3 cyclically until the preset load growth step length is less than the corresponding convergence threshold, if the preset load growth step length is greater than or equal to the corresponding convergence threshold.

4. The acquisition method of claim 1, wherein the acquiring the critical node of the interconnected power system under the current load in step S1 further comprises:
acquiring CNSIs of all the nodes in an arbitrary region of the interconnected power system based on a CNSI equation and selecting a regional critical node of the arbitrary region based on the CNSIs of all the nodes;
selecting the critical node of the interconnected power system under the current load from the regional critical nodes of all the regions;
the CNSI equation is as follows:
S_{k,i}=E_{k,i}(δₘᵢₙ^{k},Vᵢ)−R_{k,i}(Qₖ^{B},Vᵢ);
wherein S_{k,i} is the CNSI, E_{k, i}(δₘᵢₙ^{k}, Vᵢ) is a derivative of the severest modulus eigenvalue of the Jacobian matrix of the power flow equation of the region where the node is located in, with respect to the voltage amplitude thereof, δₘᵢₙ^{k} is the severest modulus eigenvalue of the Jacobian matrix of the power flow equation of the region where the node is located in, k represents the k-th regional power grid, i represents the i-th node, Vᵢ is the voltage amplitude of the node, R_{k, i}(Qₖ^{B}, Vᵢ) is a partial derivative of an external reactive power injection amount with respect to the voltage amplitude of the node, Qₖ^{B} is an external reactive power injection amount, and B represents the boundary.

5. The acquisition method of claim 4, wherein the selecting a regional critical node of the arbitrary region based on the CNSIs of all the nodes further comprises: selecting a node of which both E_{k, i}(δₘᵢₙ^{k}, Vᵢ) and R_{k, i}(Qₖ^{B}, Vᵢ) have the maximum value as regional critical node of the arbitrary region from the CNSIs of all nodes.

6. The acquisition method of claim 1, wherein in step S2, the calculating the amount of the load growth of each partition of the interconnected power system according to the partial derivative and the preset load growth step length is performed by the following equation:
$$Δλ = s \cdot \frac{\frac{\partial {V}_{cb}}{\partial λ}}{{‖ \frac{\partial {V}_{cb}}{\partial λ} ‖}_{2}} ;$$
wherein Δλ is the amount of the load growth of each partition of the interconnected power system, s is the preset load growth step length,
$$\frac{\partial {V}_{cb}}{\partial λ} = [ \frac{\partial {V}_{cb}}{\partial {λ}_{1}} , \frac{\partial {V}_{cb}}{\partial {λ}_{2}} , … , \frac{\partial {V}_{cb}}{\partial {λ}_{M}} ]$$
is the partial derivative of the initial voltage amplitude of the critical node with respect to the load level of each partition of the interconnected power system, M is the number of regional power grids, V_{cb} is a voltage of the critical node, and λ_{M} is the load of the M-th regional power grid, and wherein
$$\frac{• {V}_{cb}}{• }$$
is calculated by the finite difference method.

7. The acquisition method of claim 1, wherein in step S2, the updating the active power output and the current load in the interconnected power system according to the amount of the load growth based on the coordinated continuation power flow model further comprises:
according to the amount of the load growth based on the coordinated continuation power flow model below. the active power output and the current load in the interconnected power system are updated by the following equations:
$$\{ \begin{matrix}{p}_{Gk} = {p}_{Gk}^{0} + {λ}_{k} \cdot {p}_{Gk}^{0} \\ {p}_{Lk} = {p}_{Lk}^{0} + {λ}_{k} \cdot {p}_{Lk}^{0} \\ {q}_{Lk} = {q}_{Lk}^{0} + {λ}_{k} \cdot {q}_{Lk}^{0}\end{matrix} ;$$
wherein p_{Gk} is an active power output of the generator of the kth regional power grid, p_{Lk} is an active load of the kth regional power grid, q_{Lk} is a reactive load of the kth regional power grid, p_{Gk}⁰ is an active power output of the generator corresponding to the base state, p_{Lk}⁰ is an active load corresponding to the base state, q_{Lk}⁰ is a reactive load corresponding to the base state, and λₖ is a load level of the kth regional power grid;
the coordinated continuation power flow model is
G(Y,λ)=0;
wherein Y is the set of algebraic variables of coordinated continuation power flow calculation, and λ is the load level.

8. The acquisition method of claim 1, wherein step S3 further comprises:
S31, dividing the interconnected power system into a calculating side and a coordinating side;
S32, receiving a power injection vector of a boundary node and a phase angle of a balanced node observed from the regional power grid transmitted from the coordinating side, and transmitting the power injection vector of the boundary node and the phase angle of the balanced node observed from the regional power grid to the calculating side such that the calculating side acquires a boundary voltage vector and an unbalanced power vector of each region by the following equation:
[U_{B},Pₗₒₛₛ,]=f_{Ω}(P_{B}^{t},Q_{B}^{t},θ₀^{t})
wherein U_{B} is the boundary voltage vector, Pₗₒₛₛ is the unbalanced power vector of each region, [symbol] , Q_{B}^{t}[ is the power injection vector of the boundary node observed from the regional power grid, [symbol] is the phase angle of the balanced node, and f_{Ω} corresponds to the regional power flow;
S33, receiving the boundary voltage vector and the unbalanced power vector of each region transmitted from the calculating side, and transmitting the boundary voltage vector and the unbalanced power vector of each region to the coordinating side, such that the coordinating side acquires an injection power of a link line through the following equation;
[P_{\tilde{B}},Q_{\tilde{B}}]=f_{All}(U_{\tilde{B}});
wherein [symbol] , Q_{\tilde{B}}[ is a power injection vector of the boundary node observed from the coordinating side, U_{\tilde{B}}=U_{B}, U_{\tilde{B}} is the boundary voltage vector transmitted to the coordinating side, and f_{All} corresponds to a link line partition power flow equation;
S34, judging whether the following coordination equation is true:
$$\{ \begin{matrix}{P}_{B}^{t} - {P}_{\tilde{B}}^{t} = 0 \\ {Q}_{B}^{t} - {Q}_{\tilde{B}}^{t} = 0 \\ {P}_{loss} - K \cdot {P}_{loss}^{all} = 0\end{matrix} ;$$
wherein [symbol] , Q^{t}_{B}[ is the power injection vector of the boundary node observed from the regional power grid, [symbol] , Q_{\tilde{B}}[ is the power injection vector of the boundary node observed from the coordinating side, Pₗₒₛₛ is the unbalanced power vector of each region, K is the unbalanced power distribution coefficient, and Pₗₒₛₛ^{all} is the unbalanced power vector of all regions;
if it is true, the coordinated power flow of the updated interconnected power system converges and whether a voltage of the critical node is less than a set voltage is further determined.

9. The acquisition method of claim 8, wherein after step S34, the method further comprises:
S35, if it is false, the coordinated power flow of the updated interconnected power system does not reach convergence, then the residual errors are acquired by the following equations:
$$\{ \begin{matrix}{P}_{B}^{t} - {P}_{\tilde{B}}^{t} = {dP}_{B} \\ {Q}_{B}^{t} - {Q}_{\tilde{B}}^{t} = {dQ}_{B} \\ {P}_{loss} - K \cdot {P}_{loss}^{all} = {dP}_{loss}\end{matrix} ;$$
wherein [symbol] , Q_{B}^{t}[ is the power injection vector of the boundary node observed from the regional power grid, [symbol] , Q_{\tilde{B}}[ is the power injection vector of the boundary node observed from the coordinating side, Pₗₒₛₛ is the unbalanced power vector of each region, K is the unbalanced power distribution coefficient, and Pₗₒₛₛ^{all} is the unbalanced power vector of all regions, and d_{PB}, d_{QB} and dPₗₒₛₛ all are residual errors;
S36, calculating corrected values by using a JFNG(m) algorithm based on the residual errors, and correcting the power injection vector of the boundary node and the phase angle of the balanced node observed from the regional power grid by the following equations based on the corrected values:
$$\{ \begin{matrix}{P}_{B}^{t + 1} = {P}_{B}^{t} + Δ {P}_{B} \\ {Q}_{B}^{t + 1} = {Q}_{B}^{t} + Δ {Q}_{B} \\ {θ}_{0}^{t + 1} = {θ}_{0}^{t} + Δ {θ}_{0}\end{matrix} ;$$
wherein [symbol] , Q_{B}^{t}[ is the power injection vector of the boundary node observed from the regional power grid, [symbol] is the phase angle of the balanced node, [symbol] , Q_{B}^{t□1}[ is a corrected power injection vector of the boundary node observed from the regional power grid, [symbol] is a corrected phase angle of the balanced node, and ΔP_{B}, ΔQ_{B} and Δθ₀ are all corrected values; and
S37, cyclically performing steps S1 to S3 until the coordinated power flow of the updated interconnected power system converges.

10. A system for acquiring the severest voltage stability margin based on coordinated continuation power flow, comprising:
a partial derivative acquisition module, suitable for acquiring a critical node of an interconnected power system under a current load, and calculating a partial derivative of initial voltage amplitude of the critical node with respect to the load level of each partition of the interconnected power system;
an updating module, suitable for calculating an amount of the load growth of each partition of the interconnected power system according to the partial derivative and a preset load growth step length, and updating an active power output and the current load in the interconnected power system according to the amount of the load growth based on a coordinated continuation power flow model;
a voltage judgment module, suitable for judging whether a new voltage amplitude of the updated critical node is less than the initial voltage amplitude if the coordinated power flow of the updated interconnected power system converges; and
the severest voltage stability margin acquisition module, suitable for judging whether the preset load growth step length is less than a corresponding convergence threshold if the new voltage amplitude is greater than or equal to the initial voltage amplitude, and acquiring the severest voltage stability margin based on the updated loads of the interconnected power system if the preset load growth step length is less than the corresponding convergence threshold.
